(19) United States
(12) Patent Application Publication
(10) Pub. No.: US 2020/0288692 A1
(43) Pub. Date: Sep. 17, 2020

(54) MOORING CLEAT FISHING ROD HOLDER

(71) Applicant: Jonathon Riley, Kearney, MO (US)

(72) Inventor: Jonathon Riley, Kearney, MO (US)

(21) Appl. No.: 16/355,684

(22) Filed: Mar. 15, 2019

(51) Int. Cl. A01K 97/10

(52) U.S. Cl. CPC A01K 97/10

(57) ABSTRACT

The present invention provides improved fishing rod holders, as well as, methods of using the devices. These fishing rod holders do not require separate hardware or clamps and are readily and easily moved from one location to another. Advantageously, these fishing rod holders do not require that the structures to which they are attached include holes for fasteners and removal of these fishing rod holders does not damage the surfaces to which they are attached.

### BACKGROUND OF THE INVENTION

### A. Field of the Invention

The present invention relates to sports equipment, specifically to fishing rod holders.

### B. Description of the Related Art

Fishermen often use fishing rod holders to hold their fishing rods while they attend to other tasks or to be able to fish with more than one rod at a time. A fishing rod holder is often mounted by using an existing fixture such as a cleat or rail. These cleats or rails serve other purposes such as allowing a boat to be tied to a dock, so there is competition for their use to mount a fishing rod holder. Further, these structures are usually located only at specific locations, such as the bow or stern of a boat, which limits the placement of fishing rod holders.

Other fishing rod holders are essentially two-part devices in which a first part (i.e. hardware) is permanently affixed to a boat and a removable second part, which is connected to the first part, holds a fishing rod. Often, mounting the hardware or the rod holder itself requires invasive alterations such as drilling holes in the boat. Many fishermen cringe at the idea of drilling holes in their new boat. The few rod holders that do attach to mooring cleats require clamping hardware or are made of steel and are heavy and bulky. Further, because boats often serve dual fishing and recreational purposes, the hardware used to affix a rod holder often needs to be removed so that recreational activities can be conducted. Removal of the hardware can be time-consuming and inconvenient. Improved fishing rod holders that do not have these disadvantages are desirable.

### SUMMARY OF THE INVENTION

The present invention provides an improved fishing rod holder that does not require separate hardware or clamps and is moved easily and quickly from one location to another without damaging a boat or other vehicle to which it has been attached.

As compared to known fishing rod holders, the invention provides devices that are smaller and lighter weight. Further, devices of the invention do not necessitate drilling holes into a boat or other vehicle to affix them securely in place. These devices are readily moved from one position to another without leaving unsightly holes or other damage to the surface to which they have been attached.

A device of the invention comprises a combination of a fishing rod holder with a base having two hooks (or ears) that fasten around a cleat (e.g. a mooring cleat), gunnel, or rail so that the device is held in place.

More specifically, the invention provides a fishing rod holder that comprises a base; a barrel that extends upward from the base; and a first hook and a second hook that extend downward from the base, wherein one side of the first hook and one side of the second hook are formed by the base's bottom, and the first hook's open end and the second hook's open end are aligned with each other in the same direction.

Preferably, the first and second hooks are U-shaped or C-shaped. While U-shaped or C-shaped hooks are preferred, those of skill in the art will appreciate that the shape, length, and width of both hooks will depend at least in part upon what structure (e.g. a mooring cleat, rail, alternative type of cleat, etc.) the hooks are to be attached. For example, there are many differently shaped cleats on boats and docks; and the gunnel of a boat and the rail surrounding the bed of a pickup truck may have different shapes. Further, the gunnel of a rowboat and the gunnel of a yacht may have different sizes. Thus, different devices of the invention can have differently shaped hooks (or ears) so that they are better suited to a particular type or size of cleat, dock structure, or vehicle.

A fishing rod holder of the invention includes a barrel that is hollow and has a top open end and a bottom open end. The butt of a fishing rod can be inserted through the top end of the barrel so that the butt rests within the barrel of the fishing rod holder. The bottom open end of the barrel is located with the base and between the first and second hooks.

In some embodiments of the invention, the interior surfaces of both the first and second hooks are textured. Textures include ridges, dimples, grooves, bumps, or other irregularities. A textured surface is not necessary for the functioning of the hooks or ears of the embodiments. Texturing is helpful during manufacture by molding (e.g. injection molding or matrix molding) to prevent or reduce warping after removal of a device from a mold and during cooling.

In some embodiments of the invention, the top open end of the barrel is tapered relative to the bottom open end of the barrel. In other embodiments, the top open end of a barrel and the bottom open end of a barrel have similar diameters.

Some embodiments of the invention include a detachable, stretchable fastener. The fastener is suitable for securing devices of the invention in place and assisting with maintaining fishing rods securely in the barrels of the devices. While there are many known, suitable, stretchable fasteners available, preferred ones include bungee cords, rubber bands, or elastic bands.

Those of skill in the art will appreciate that devices of the invention may be made from plastic, wood, metal, or a combination thereof. Preferably, devices of the invention are made from one or more plastics. Preferred plastics include fiberglass, nylon, or combinations of fiberglass with nylon such as a fiberglass filled with nylon. Those of skill in the art will be aware of the many types of plastics that are widely available and that many are suitable for use in devices of the invention. For example, suitable plastics can include polycarbonates, polyethylenes, polypropylenes, polyethylene terephthalates, polyvinyl chlorides, thermoplastics, thermosetting polymers, elastomers, or combinations thereof.

The invention further provides an improved method for detachably connecting a fishing rod holder to a cleat. More specifically, the invention provides a method that comprises: (a) providing a fishing rod holder having a base, a barrel, a first hook, and second hook, wherein the barrel extends upward from the base, the first and second hooks extend downward from the base, one side of the first hook and one side of the second hook are formed by the base's bottom, and the first hook's open end and the second hook's open end are aligned with each other in the same direction; (b) attaching the fishing rod holder to a cleat by fastening the first hook and second hook of the fishing rod holder over, under, or around the cleat such that the barrel of the fishing rod holder points outwardly; and (c) detaching the fishing rod holder from the cleat by disengaging the first and second hooks of the fishing rod holder from the cleat.

In a preferred embodiment, the improved method for detachably connecting a fishing rod holder to a cleat further includes securing the fishing rod holder in place with a stretchable fastener, and before detaching the first and second hooks of the fishing rod holder from the cleat, removing the stretchable fastener.

Methods of the invention further comprise inserting a butt of a fishing rod through the open end of the barrel such that the fishing rod is held by the fishing rod holder.

Preferably, devices of the invention are attached to a cleat that is attached to a dock or vehicle, e.g. a boat or truck, such that the barrel of the fishing rod holder points away from the user. Depending upon the type of cleat and its orientation to the boat, dock, or vehicle to which it is attached, the barrel of the fishing rod holder points away from a user at approximately a 30° to 60° angle and outwardly over a body of water such as a lake, ocean, or river.

The invention further provides a kit comprising (a) a fishing rod holder that has a base; a barrel extending upward from the base; and a first hook and a second hook extending downward from the base, wherein one side of the first hook and one side of the second hook are formed by the base's bottom and the first hook's open end and the second hook's open end are aligned with each other in the same direction; and (b) a stretchable fastener. Preferably, the stretchable fastener is a bungee cord, rubber band, or elastic band.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description. Further, while specific advantages of the invention are detailed herein, various embodiments may include some, none, or all of these enumerated advantages.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description presented herein. Unless specifically noted, articles depicted in the drawings are not necessarily drawn to scale.

FIG. 1 is a side and front perspective view of an embodiment of the invention.

FIG. 2 is a side and back perspective view of an embodiment of the invention.

FIG. 3 is a perspective view of an embodiment of the invention from below.

FIG. 4 is a lateral view of an embodiment of the invention.

FIG. 5 is a top view of an embodiment of the invention.

FIG. 6 is a view from below of an embodiment of the invention.

FIG. 7 is a front view of an embodiment of the invention.

FIG. 8 is a side perspective view of another embodiment of the invention.

### DETAILED DESCRIPTION

The invention provides improved fishing rod holders and methods of using these devices. While some variation in the sizes, shapes, and materials from which devices of the invention are manufactured exist, all embodiments of the invention share the features described herein.

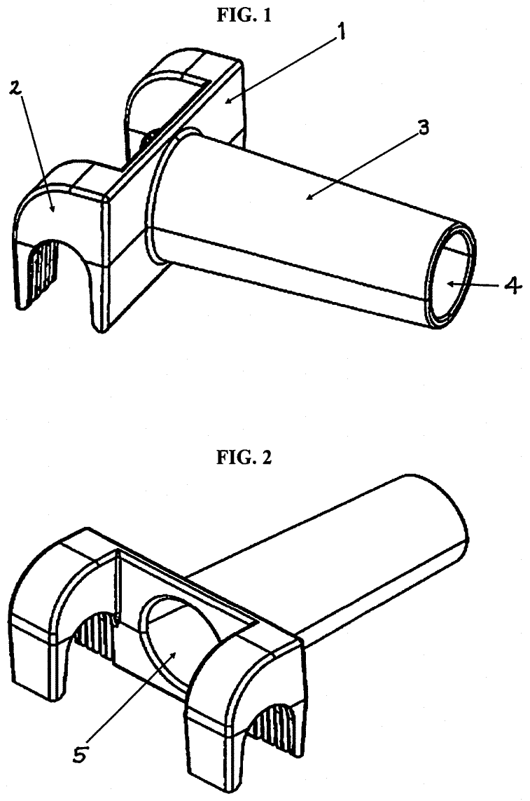

A fishing rod holder of the invention has a base 1, two hooks 2, and a barrel 3. See FIG. 1. The base 1 is generally rectangular in shape. The barrel 3 is hollow and extends upward from the central portion of the base 1. The barrel 3 is approximately perpendicular to the base 1. A hook 2 extends downward from each of the short sides of the rectangular base 1.

The barrel 3 is approximately perpendicular to the base 1. The barrel 3 has a first open end 4 and preferably a second open end 5. See FIGS. 1 and 2. The first open end 4 is located away from the base 1 and is the aperture through which the butt of a fishing rod can be inserted into the barrel 3. The second open end 5 is located within the central portion of the base 1. An advantage of having a second open end is that water can drain away from the barrel 3.

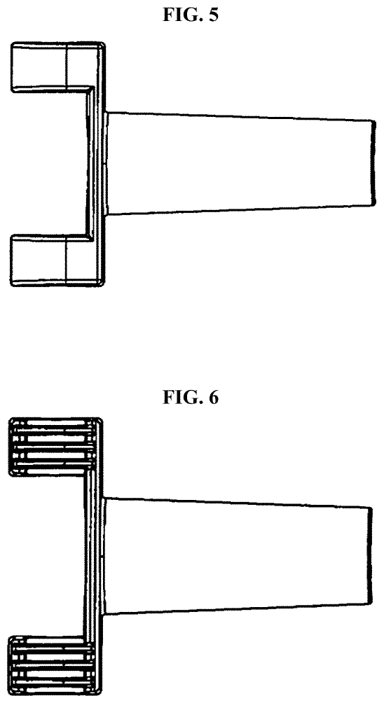

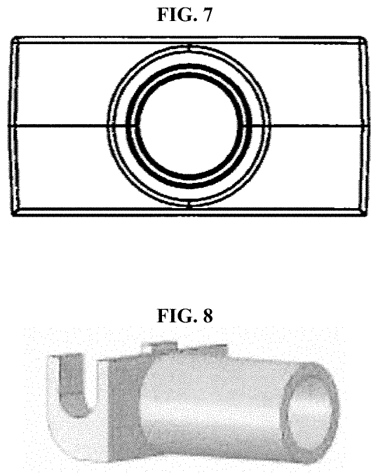

While there is no limit to the length or diameter of the barrel 3, its length is generally suited to the typical dimensions of a butt of a fishing rod. In some embodiments of the invention, the barrel 3 is tapered at its first open end 4 relative to its second open end 5. See FIGS. 4-6. In other embodiments, the barrel 3 is not tapered, and the first open end 4 and second open end 5 are of about the same diameter. See FIG. 8. Those of skill in the art will appreciate that the thickness of the barrel 3 can vary depending upon the materials from which it is made. That is, the barrel may be thinner when made from stronger materials.

Each hook 2 (or ear) is generally curved in shape. Preferably, a hook is either U-shaped or C-shaped. One side of each hook 2 is formed by the base 1. Both hooks are formed so that each of their respective open ends are aligned with one another and face the same direction. While the dimensions of the hooks will vary and depend in part upon the material(s) from which they are made, the hooks should be of sufficient width and thickness to withstand the likely stresses to which the device will be subjected during use. For example, the hooks for a fishing rod holder that is to be used for deep sea fishing will likely need to be more substantial than the hooks for a fishing rod holder that is to be used with a fishing rod by a child on an inland lake.

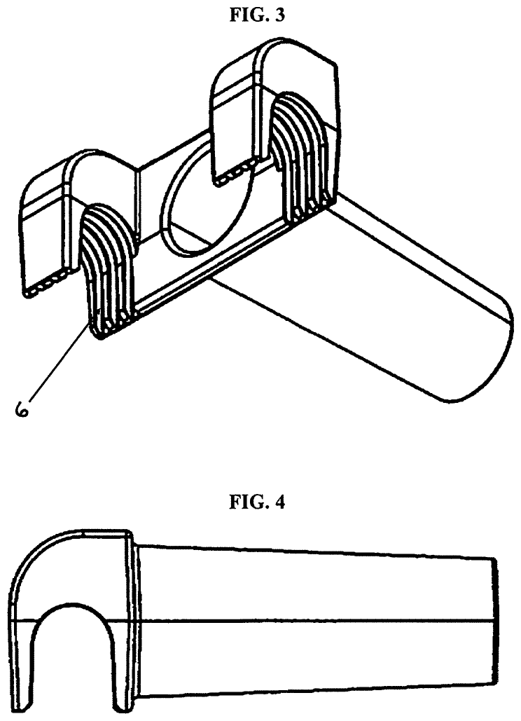

In some embodiments, the interior surface 6 of each hook 2 is textured. See FIG. 3. In other embodiments, the interior surface 6 of each hook 2 is relatively smooth. See FIG. 8. Skilled artisans will understand that a wide variety of textures exist. For example, a textured surface may include ridges, dimples, grooves, bumps, or combinations thereof.

Kits of the invention include a fishing rod holder and a stretchable fastener (not shown) such as a bungee cord, rubber band, elastic band, or combination thereof. The fastener is used to secure a fishing rod holder of the invention after it has been attached to a cleat. Those of skill in the art will appreciate that a variety of configurations of such fasteners can be used to secure fishing rod holders of the invention, and which configuration a user chooses will depend upon the user's personal preferences, the type and length of the fastener, and the configuration of the cleat to which the fishing rod holder is to be secured, as well as, the cleat's positioning on a dock, boat, vehicle, or other surface to which the cleat is affixed.

The invention also provides a method for detachably connecting devices of the invention to a vehicle. More specifically, the invention provides that a user can attach a fishing rod holder to a vehicle by fastening the hooks 2 (or ears) of a holder over a mooring cleat, gunnel, or rail of a vehicle such that the barrel 3 of the fishing rod holder points away from a user and over or towards a body of water (i.e. a lake, river, ocean, etc.). Once securely attached to a cleat, the barrel 3 of the fishing rod holder points away from the user at approximately a 30 to 60 degree angle. Those of skill in the art will appreciate that the angle relative to the base of the mooring cleat will vary depending on the type of cleat and its orientation to the structure to which the cleat is attached.

A user can secure the fishing rod holder at the position with a stretchable fastener. Those of skill in the art will be familiar with stretchable fasteners such as bungee cords, elastic bands or rubber bands and how to use such fasteners.

Optionally, the user can immediately insert the butt of a fishing rod into the barrel 3 of the fishing rod holder.

When the user wishes to detach the fishing rod holder, the user removes any fishing rod from within the holder; removes any stretchable fastener; and then detaches the hooks 2 of the fishing rod holder from the cleat, gunnel, rod, or rail to which the fishing rod holder had been attached.

It should be noted that the accompanying drawings depict devices of the invention from various angles and include a variety of lines within each part of the devices. These lines do not indicate further parts or subparts. Rather, the lines indicate exemplary seams for molds from which to manufacture devices of the invention. Those of skill in the art will appreciate that different seam lines could be used to either create suitable molds or to create subparts that can be assembled into devices of the invention.

Preferably, devices of the invention are made as a single piece by injection molding, or a similar process. But, those of skill in the art will recognize that each part of a device may be made separately and then assembled into a finish device.

Herein, “cleat” refers to a structure—such as a wedge, pole, or rail—that has at least one arm or extension that is suitable for securing a fishing rod holder by its hooks. There are many types of cleats on a boat such as belaying cleat, deck cleat, mooring cleat, etc. Similarly, different types of cleats are present on a dock. A preferred type of cleat to use with devices of the invention are mooring cleats; however, those of skill in the art will recognize that other types of cleats can be used with the invention. In another type of vehicle, such as a truck, a rod, pole, or rail may be considered to be a “cleat” in reference to the invention. Suitable structures that can be considered “cleats” either have two arms or extensions about which devices of the invention may be attached with one hook fastened around each arm or extension; or alternatively, suitable structures have at least one arm that is of sufficient length and suitable diameter for both hooks of devices of the invention to fasten around the arm or extension.

Unless defined otherwise, all technical and scientific terms used herein have the same meaning as is commonly understood by one of skill in the art to which this invention belongs at the time of filing. Terminology used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. Furthermore, the use of the term “including”, as well as other forms such as “includes” and “included” is not limiting. As used herein, “each” refers to each member of a set or each member of a subset of a set. Any patents or publications referred to herein are incorporated by reference to the extent that they providing teachings or information that is helpful in the practice of the claimed invention.

It should be appreciated by those of skill in the art that any techniques disclosed herein represent techniques found to function well in the practice of the invention, and thus can be considered to constitute preferred modes of practice. However, those of skill in the art should, in light of the present disclosure, appreciate that many changes can be made to the embodiments which are disclosed and still obtain a like or similar result without departing from the spirit and scope of the invention. Thus, the present invention should not be limited to the illustrative embodiments and techniques presented herein.

What is claimed is:

1. A fishing rod holder comprising
a) a base;
b) a barrel extending upward from the base; and
c) a first hook and a second hook extending downward from the base, wherein one side of the first hook and one side of the second hook are formed by the base's bottom and the first hook's open end and the second hook's open end are aligned with each other in the same direction.

2. The fishing rod holder of claim 1, wherein the first and second hooks are U-shaped or C-shaped.

3. The fishing rod holder of claim 1, wherein the first hook's interior surface and the second hook's interior surface are textured or smooth.

4. The fishing rod holder of claim 1, wherein the barrel is hollow and has top open end and a bottom open end.

5. The fishing rod holder of claim 4, wherein the barrel can accept a butt of a fishing rod through its top open end.

6. The fishing rod holder of claim 4, wherein the bottom open end of the barrel is in the base and between the first and second hooks.

7. The fishing rod holder of claim 4, wherein the top open end of the barrel is tapered relative to the bottom open end.

8. The fishing rod holder of claim 4, wherein the top open end and the bottom open end of the barrel have similar diameters.

9. The fishing rod holder of claim 1 further comprising a detachable, stretchable fastener.

10. The fishing rod holder of claim 9, wherein the detachable, stretchable fastener is a bungee cord, rubber band, or elastic band.

11. The fishing rod holder of claim 1, wherein the fishing rod holder is comprised of an fiberglass, nylon, plastic, wood, metal, or a combination thereof.

12. The fishing rod holder of claim 11, wherein the fishing rod holder is comprised of an exterior of fiberglass and an interior of nylon.

13. The fishing rod holder of claim 11, wherein the fishing rod holder is comprised of polycarbonate, polyethylene, polypropylene, polyethylene terephthalate, polyvinyl chloride, or a combination thereof.

14. A method for detachably connecting a fishing rod holder to a cleat comprising
a) providing a fishing rod holder having a base, a barrel, a first hook, and a second hook, wherein the barrel extends upward from the base, the first and second hooks extend downward from the base, one side of the first hook and one side of the second hook are formed by the base's bottom, and the first hook's open end and the second hook's open end are aligned with each other in the same direction;
b) attaching the fishing rod holder to a cleat by fastening the first hook and second hook of the fishing rod holder over, under, or around the cleat such that the barrel of the fishing rod holder points outwardly; and
c) detaching the fishing rod holder from the cleat by unhooking the first and second hooks of the fishing rod holder from the cleat.

15. The method of claim 14 further comprises securing the attached fishing rod holder in place with a stretchable fastener and before detaching the first and second hooks from the cleat removing the stretchable fastener.

16. The method of claim 15, wherein the stretchable fastener is a bungee cord, rubber band, or elastic band.

17. The method of claim 14 wherein after the fishing rod holder is attached to the cleat the barrel of the fishing rod holder points away from a user at approximately a 30 degree to 60 degree angle.

18. The method of claim 14 further comprises inserting a butt of a fishing rod through the open end of the barrel such that the fishing rod is held by the fishing rod holder.

19. A kit comprising
a) a fishing rod holder having
i) a base;
ii) a barrel extending upward from the base; and
iii) a first hook and a second hook extending downward from the base, wherein one side of the first hook and one side of the second hook are formed by the base's bottom and the first hook's open end and the second hook's open end are aligned with each other in the same direction; and
b) a stretchable fastener.

20. The kit of claim 19, wherein the stretchable fastener is a bungee cord, rubber band, or elastic band.
